(19) United States
(12) Patent Application Publication
(10) Pub. No.: US 2020/0169627 A1
(43) Pub. Date: May 28, 2020

(54) WRIST WEARABLE DEVICE ACTIVATION

(71) Applicant: Yoav Netzer, Moers (DE)

(72) Inventor: Yoav Netzer, Moers (DE)

(21) Appl. No.: 16/776,943

(22) Filed: Jan. 30, 2020

Related U.S. Application Data
(63) Continuation-in-part of application No. PCT/IL2018/050832, filed on Jul. 26, 2018.

(51) Int. Cl. H04M 1/725; H04B 1/3827

(52) U.S. Cl. CPC H04M 1/7253; H04B 1/385; H04M 1/72552

(57) ABSTRACT

This application provides a wearable apparatus comprising an electronic device, an armband suitable for encircling a portion of a user's arm and physically connected to the electronic device, one or more sensor pads (SPs) operably connected to the electronic device, and a functional module comprised in the electronic device configured to perform a function responsive to activation of the one or more SPs. Optionally, the one or more SPs are positioned in the wearable device so that the functional module performs the function responsive to pressure applied to the armband.

### RELATED APPLICATIONS

This application is a continuation-in-part of PCT/IL2018/050832 filed on Jul. 26, 2018, the disclosure of which is incorporated herein by reference.

### BACKGROUND

Technology is increasingly becoming incorporated into daily life and extending the functionality of our clothing to incorporate technology is an example of this phenomena. Whereas wearable technology of any complexity was, until the last decade, confined largely to the realm of defense gear, its use is becoming more widespread. Wearable technology has been available to the public for over hundred years. The oldest and most popular example of wearable technology is the wrist watch which not only combines the benefit of the technology with the convenience of being wearable but may also provide aesthetic benefits. Wearable technology has since extended into the realm of calculators, pedometers, heart-rate monitors, global positioning system-related technologies and mobile phones.

Arm-wearable devices (AWDs) are electronic devices connected to or otherwise incorporated within one or more bands that are configured to encircle a portion of an arm, optionally a forearm or a wrist, of a user. Examples of arm-wearable include wrist-wearable fitness trackers and smart watches that are wearable watches which, in addition to serving as a watch, include some or all of the features of a “smart phone”; for example, phone, compass, radio, music player, storage of data and camera facilities. In some examples, AWDs are configured to able to communicate with another computing device such as a smartphone over short range wireless communication modalities such as through Bluetooth.

### SUMMARY

An aspect of an embodiment of the disclosure relates to providing a smart armband for controlling a function of an electronic device operatively connectable thereto, optionally through coordinated pressure applied to at least one or at least two separate portions of the smart armband.

Another aspect of an embodiment of the disclosure relates to providing an AWD comprising an electronic device and a smart armband operatively connected thereto, in which a function of the electronic device can be controlled, optionally through coordinated pressure applied to two separate portions of the smart armband.

Optionally, a functional module of the electronic device that may be controlled by the smart armband comprises a selection from the group consisting of: initiation of image capture by a camera; transmission of a wireless communication signal from the device, activation of a chemical sensor for detecting presence of a volatile chemical, and activation of a bio-sensor for detecting a biological parameter of user wearing the arm-wearable device.

In accordance with an embodiment of the disclosure, a smart armband band comprises two or more sensor pads (SPs), the one or more device functionalities being configured to be initiated responsive to a temporally overlapping, optionally simultaneous, activation of the two or more SPs. Optionally at least one of the SPs are embedded in the one or more arm bands.

In an embodiment, the two or more SPs comprise a pair of SPs. The SPs may be situated in the smart armband such that, when the AWD is worn on a forearm of a user, the SPs are positioned at opposing sides of the forearm. Optionally, the pair SPs comprises an “ulnar SP” that is situated in the smart armband to be at or near the ulnar side of the forearm when worn and a “radial SP” that is situated in the smart armband to be at or near the radial side of the forearm when worn. Optionally, the pair of ulnar and radial SPs are situated on the smart armband such that, when an AWD is worn by the user on the forearm, pressure placed on the pair of SPs results in the electronic device being pressed and/or stabilized onto the forearm of the user.

In an embodiment, a smart armband comprises two armband sections configured to be connectable to opposing sides of the electronic device. Each SP of a pair of SPs, optionally a radial SP and an ulnar SP, may be embedded respectively in each of the two armband sections.

In an embodiment, the two or more SPs comprises one SP, which may be referred to as an “underbody SP” situated on a back surface of the electronic device, such that the SP faces the forearm of the user when worn by the user. Optionally, the functional module is operable to be controlled through temporally overlapping, optionally simultaneous, activation of at least one SP situated on a smart armband, optionally an ulnar SP or a radial SP, and an underbody SP. Optionally, the functional module is configured to be controlled through temporally overlapping, optionally simultaneous, activation of an underbody SP and at least two SP situated on a smart armband, optionally an ulnar SP and a radial SP.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 shows a schematic perspective-view illustration of an AWD in a closed position, in accordance with an embodiment of the disclosure;

FIG. 2 shows a schematic illustration of an AWD in an open position in accordance with an embodiment of the disclosure; and

FIG. 3 shows a schematic side-view of an AWD in a closed position in accordance with an embodiment of the disclosure.

### DETAILED DESCRIPTION

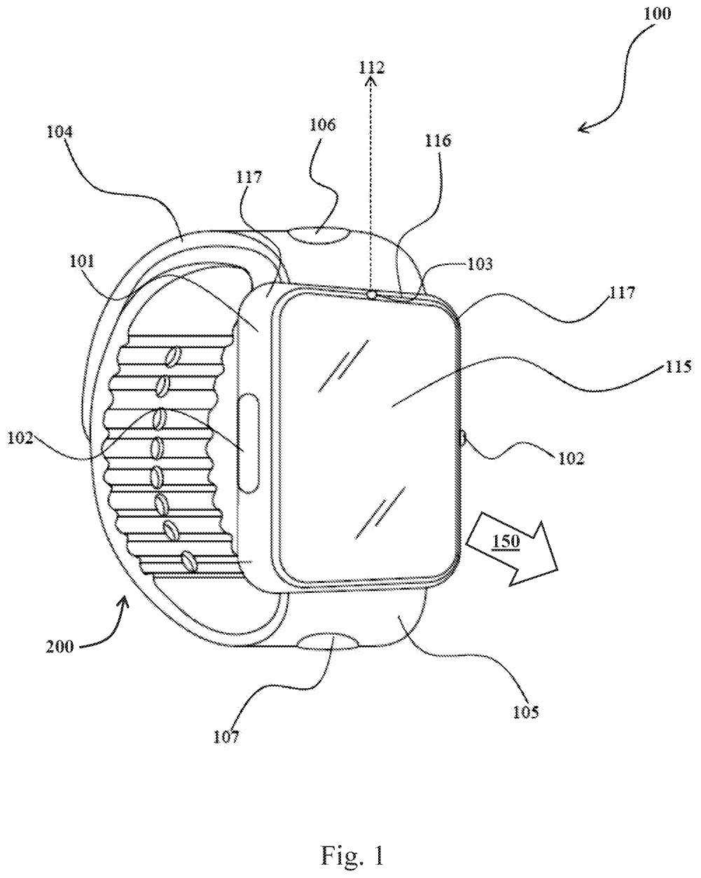

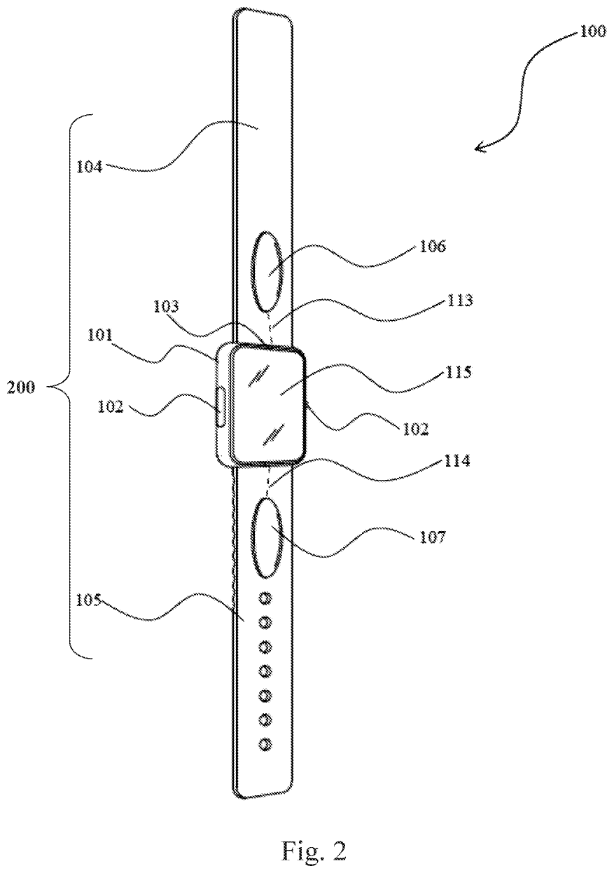

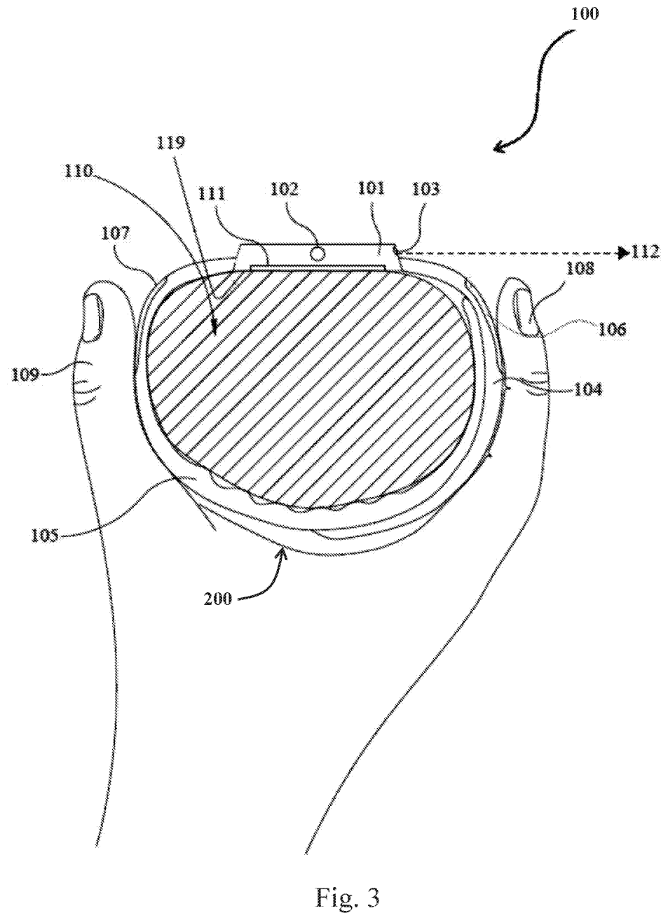

FIG. 1 shows a schematic perspective-view of an AWD 100. The disclosed device comprises a electronic device 101 that is physically and operatively connected to a smart armband 200 comprising a pair of sensor pads (SPs), SP 106 and SP 107. Optionally, AWD 100 is configured so that a temporally overlapping, optionally simultaneous, activation of SP 106 and/or SP 107 controls a functional module comprised in electronic device 101. Whereas armband 200 is shown in FIG. 1 (as well as FIGS. 2-3) as being comprised of a first strap 104 and a second strap 105 that are connected to form a loop, armband 200 may alternatively be shaped as a single, optionally stretchable, loop.

Electronic device 101 comprises at least one processor (not shown) and at least one memory (not shown). Electronic device 101 may by way of example comprise a device casing having a rectangular shape with rounded edges for aesthetic purposes as shown in FIG. 1, or alternatively the device casing may be circular in shape. The electronic device may include a touch-sensitive screen 115, thereby mitigating the need for multiple buttons. Optionally, electronic device 101 comprises one or more push buttons 102, wherein the buttons are used to activate a functional module of the electronic device.

A functional module controllable by smart armband 200 in accordance with an embodiment of the disclosure may be a hardware module that is configured to perform a given function and is comprised in or operatively connected to electronic device 101. Alternatively or additionally, the functional module may be a software module that is executed by a processor comprised in the electronic device, based on a set of instructions and/or data stored a memory comprised in the electronic device. The functional module may be, by way of example, an image capture device; a wireless communication module; a sound recording module; a light source; a location tracking module; a chemical sensor for detecting presence of a volatile chemical, and a bio-sensor configured to detect and record biological data from the user wearing the AWD.

An image capture device may be a camera, a radar sensor, a lidar sensor, or a range finder sensor. As disclosed herein, an “image” captured by an image capture device refers to a representation of a field of view responsive to electromagnetic waves generated by or reflected from objects in the field of view and captured by the image capture device. Optionally the electromagnetic waves are generated by an appropriate electromagnetic wave generator comprised in or operatively connected to AWD 100. Where the image capture device is a camera, the electromagnetic waves are typically (but not necessarily) within or near visible spectrum of frequencies. Where the image capture device is a radar, the electromagnetic waves are radio waves. Where the image capture device is a lidar or a range finder, the electromagnetic waves are in the form of laser pulses.

In a case of the functional module being an image capture device such as a camera, an initiation of the functional module controlled by smart armband 200 may comprise initiating capture of one or more of a single image, a burst of multiple images captured in succession, or a movie. The camera may be configured to change the type of image capture responsive to the duration of SP activation. By way of example, a short activation of the SPs results the camera capturing a single image and a longer duration activation results in the camera switching to capturing a burst of images. By way of a further example, a yet longer duration of SP activation results in the camera switching from capturing a burst of images to capturing a video.

As shown in FIG. 1, AWD 100 is optionally a smartwatch that comprises a camera (not shown) that is built in to electronic device 101, which is configured to receive light via a camera lens 103 from a field of view (not shown) for image capture. In an embodiment of the disclosure, camera lens 103 is built in to an upper side 116 of the electronic device, such that, when the watch is worn in the normal manner by a user, a line of sight (schematically represented as a dashed arrow 112) of camera lens 103 is directed away from the user and the field of view of the camera is positioned away from the user. Optionally, the lens is located on a lateral side 117 of electronic device 101 to allow the user to discreetly capture images that are lateral to the user. Optionally, the camera lens is built in to a bezel, which may be rotatable.

In a case of the functional module being a wireless communication module, control of the functional module by smart armband 200 may comprise initiating transmission of a wireless communication signal, schematically indicated as open arrow 150. Optionally, the wireless communication signal encodes a text-based message. The text-based message transmitted through activation of may be a predefined message and sent to a pre-defined destination. The text-based message may be, by way of example, an SMS message or an e-mail message, or any message generated and sent by one of many text-based messaging applications, such as Whatsapp®. Alternatively or in addition, activation of the one or more SPs may initiate a voice communication session, or accept and incoming voice communication session. Alternatively or additionally, activation of the one or more SPs may initiate transmission of an instruction to another device. The wireless communication module may be operable to send and receive wireless signals, messages, and/or instructions through one of any wireless communication modality known in the art, by way of example, cell-based wireless communication, Wi-Fi, and short-range radio wave communication such as Bluetooth®. Optionally, activation of the one or more SPs in accordance with an embodiment of the disclosure may initiate transmission of a request for emergency assistance to an emergency responder, or initiate a voice communication session with an emergency responder.

Optionally, activation of the one or more SPs in accordance with an embodiment of the disclosure initiates a voice-activated interface for controlling functions of electronic device 101 through voice-based commands.

A bio-sensor may be an optical or conductive sensor, optionally situated on underside 119 (see FIG. 3) of electronic device 101, that is configured to monitor one or more biological states of the user, by way of example heartrate, body temperature, or electrodermal activity. The bio-sensor may be an optical sensor, electric sensor, or other sensor appropriate for monitoring a biological state.

A location tracking module may be operable to track a location of the electronic device based on one or more of Wi-Fi, radio beacons, cells, picocells, and a satellite-based system such as Global Positioning System.

Optionally, as shown in FIG. 1, smart armband 200 comprises an first strap 104 and a second strap 105 that are connectable to form a loop suitable for encircling a portion of a user's arm (not shown), by way of example an upper forearm or a wrist. In an embodiment of the disclosure, sensor pads (SPs) are embedded into one or both of the straps, optionally with one SP 106 embedded into first strap 104 and another SP 107 embedded into second strap 105. The two SPs (106 and 107) as shown in FIG. 1 are embedded, respectively, in first strap 104 and second strap 105, so that the two SPs are positioned on either side of electronic device 101 and, with SP 106 positioned as an ulnar SP and SP 107 positioned as a radial SP. It will be appreciated that, whereas smart armband 200 is shown in FIG. 1 as comprising two connectable straps, the smart armband may alternatively comprise a single stretchable loop, with one or more appropriately situated SPs, by way of example SP 106 positioned as an ulnar SP and SP 107 positioned as a radial SP.

An SP in accordance with an embodiment of the disclosure may comprise sensors capable of detecting stimuli resultant from one or more of mechanical force, physical contact, physical proximity, or change in temperature. Optionally, the SP comprise, tactile sensors that are responsive to manual pressure. The tactile sensors optionally are mechanical buttons, capacitive touch sensors, force sensing resistors, pressure sensor arrays or strain gauges. Optionally, the tactile sensors are piezoresistive or piezoelectric sensors. The SPs may be designed such that they are operable to be activated responsive to application of a defined minimum pressure. Having the defined minimum pressure be sufficiently high provides an advantage of reducing unintended initiation of a functional module by smart armband 200. By way of example, where the functional module is a camera, the SPs being too sensitive will result in an excessive amount of unintended image capture and the image capture will occur prior to device stabilization. Conversely, the SPs requiring excessively high levels of pressure will result in unnecessary constriction of the wrist, discomfort and inefficiency in the image capture process.

FIG. 2 shows a schematic illustration of AWD 100 in an open position and illustrates substantially the same features as FIG. 1. In an embodiment of the disclosure, the SPs may be embedded into the strap subtly such that there are no external indications on the strap indicating the location of the SPs. In an alternative embodiment, a straps comprises a location indicator comprising one or a combination of two or more of a marking, an indentation, a protrusion, or a textured surface positioned to indicate a location on the strap that overlaps with an embedded SP. Optionally, a location indicator overlaps with the location of a sub-region of the SP, by way of example a center region of the SP or an edge of the SP. By way of example, the strap may comprise a plurality of indentations or protrusions in order to allow the user to easily detect, not just the location of the SP as a whole, but where on the SP pressure is being applied. Optionally, a plurality of location indicators with differing properties may differentially indicate sub-regions of a SP. By way of example, a strap may comprise a plurality of location indicators, in which a sub-region of a SP proximal to an electronic device is indicated by a first location indicator (such as a protrusion), and another sub-region of the SP more distal from the electronic device is indicated by a second location indicator (such as an indentation) having different characteristics.

In an embodiment of the disclosure, SP 106 is operatively connected to electronic device 101 via a wired connection 113 embedded in strap 104 and an electrical contact (not shown) in electronic device 101, and SP 108 is operatively connected to electronic device 101 via a wired connection 114 embedded into strap 105 and another electrical contact (not shown) in electronic device 101. In an alternative embodiment, SPs 106 and 108 may communicate with electronic device 101 via a wireless transmitter (not shown).

In an embodiment of the disclosure, AWD 100 may be operatively connected to a smartphone or a PC via a wireless connection.

FIG. 3 shows a schematic side-view of AWD 100 comprising by way of example a camera as a functional module controlled by smart armband 200. AWD 100 is shown as worn on a wrist 110 of a user wherein the image is as viewed from a hand of the user towards the user's elbow. As shown in the figure, AWD 100 is worn on a left wrist, as watches are more commonly worn on the left wrist, and lens 103 is positioned on the watch such that its line of sight 112 points outward away from the body (not shown) of the user when worn. However, operation of AWD 100 as shown may be substantially the same if worn on the right wrist.

In an embodiment, AWD 100 is configured to, when worn, prior to operation of the camera, sit loosely on the wrist 110 with the electronic device 101 sitting close to or lightly against the wrist, with camera lens 103 being situated on electronic device 101 such that line of sight 112 points away from the body of the wearer when the arm is positioned horizontally in front of the user's body. In addition, as AWD 100 is worn, SP 106 is positioned on strap 104 to be located on an ulnar side of wrist 110 and SP 107 is positioned on strap 105 to be located on the radial side of the wrist. In an embodiment of the disclosure, in order to activate image capture by the camera, a user places a thumb 109 on second strap 105 at the position of SP 107 and places finger 108 on first strap 104 at the position of SP 106 and applies pressure simultaneously to the two SPs, and the camera is configured to initiate image capture responsive to simultaneous activation of the two SPs. In an embodiment, the SPs are positioned on the respective straps such that, when the SPs are squeezed against the sides of the forearm and downwards (towards the ventral side of the wrist), electronic device 101 is pulled in a downwards direction such that it is brought into close contact with wrist 110 ensuring that electronic device 101 is advantageously stabilized with respect to the wrist, even if armband 200 is worn relatively loosely. It will be appreciated that coupling stabilization of the electronic device with control of a functional module comprised in electronic device can be advantageous. By way of example, in a case where the functional module is a camera comprised in electronic device 101, the coupling provides improved image stabilization. Alternatively, where the functional module is a biosensor located on an underside 119 of electronic device 101, the coupling provides improved contact between the biosensor and the user's skin during activation of the biosensor with smart armband 200.

In an embodiment of the disclosure, at least one of SPs 106 and 107 is configured to be slide-sensitive and is operable to be activated responsive to the user sliding a finger on the surface of the SP. Optionally, AWD 100 is configured to trigger a functional module responsive to sliding motions being simultaneously applied to SP 106 and 107. Optionally, AWD 100 is configured to trigger a functional module responsive to a user simultaneously sliding a finger and a thumb along a surface of SPs 106 and 107, respectively, away from electronic device 101, which is resting on the dorsal side of wrist 110, and toward the ventral side of the wrist, thus pulling straps 104 and 105 as well as electronic device 101 in a dorsal to ventral direction. It will appreciated that, when AWD 100 is held out on a wrist such that line of sight 112 points away from the body of the wearer when the arm is positioned horizontally in front of the user's body, with the user standing upright, such a sliding motion would be directed downwards toward the ground. In addition, such a sliding action, when AWD 100 is worn on a wrist as shown in FIG. 3, would act to pull electronic device 101 downward into closer contact with wrist 110, as described above. As such, the sliding of the thumb and finger along the SP away from electronic device 101 maybe referred to herein as a “downward slide” with respect to the ground or a “dorsoventral slide” with respect to the wrist. A slide-sensitive SP in accordance with an embodiment may comprise an array of sensors operable to detect a change in pressure, conductance, capacitance or heat caused by a user touching the surface of the slide-sensitive SP, and a transducer that is operable to register spatiotemporal patterns of sensor activation and interpret the pattern as a sliding motion, optionally characterized by a velocity and a direction. By way of example, a strap (first strap 104 and/or second strap 105) may comprise a plurality (optionally between two and six) of non-slide-sensitive SP embedded and arranged along a longitudinal segment of the strap and operatively connected to a transducer (not shown) that is operable to interpret a sequence of activations of adjacent SPs as a sliding motion. Optionally, a slide sensitive SP may be operable to detect sliding movement along a two-dimensional surface. By way of example, a slide sensitive SP may comprise a pressure mapping sensor comprising a matrix of force-sensing resistors that is placed on or embedded within smart armband 200.

In an embodiment of the disclosure, SP 107 is positioned such that it is located on the radial part of wrist 110 facing the body when line of sight 112 is pointing away from the body. In an embodiment of the disclosure, SP 107 is positioned between 2 cm and 6 cm away from electronic device 101 along the length of second strap 105. In an embodiment of the disclosure, SP 106 is positioned such that it is located on the ulnar part of wrist 110 facing away from the body when line of sight 112 is pointing away from the body. In an embodiment of the disclosure, SP 106 is positioned between 2 cm and 6 cm away from electronic device 101. In an alternative embodiment, SP 107 may be located closer to electronic device 101, for example SP 107 may be located around 1 cm from electronic device 101. It may be advantageous to position SP 106 to be sufficiently distant from electronic device 101, by way of example at least 2 cm along the length of first strap 104 in order to avoid having finger 108 obscuring the field of view in front of lens 103 when contacting SP 106.

In an embodiment of the disclosure, AWD comprises a SP 111 located on an underside 119 of electronic device 101. In an embodiment, smart armband 200 do not comprise SPs 106 and 107, and SP 111 serves as a sole SP controlling a functional module, such that applying pressure to first strap 104 and second strap 105 results in: electronic device 101 being pressed against wrist 110 and thus being stabilized, SP 111 being activated, and a functional module being controlled responsive to SP 111 activation. Advantageously, SP 111 is not too sensitive, as an overly sensitive SP 111 may result in unintended image capture, by way of example if the camera is accidentally knocked against the arm. Conversely requiring excessively high levels of pressure may result in unnecessarily cumbersome or excessive constriction of the wrist, resulting in discomfort and inefficiency in the image capture process. Optionally, SP 111 comprises an electrode or optical sensor operable to receive and/or transduce signals relevant for an ECG or heartrate monitoring functionality.

In accordance with an embodiment of the disclosure, AWD 100 comprises SP 111 in addition to one or both of SPs 106 and 107, and a functional module is controlled responsive to pressure being simultaneously applied to SP 111 and one or both of SPs 106 and 107.

In accordance with an embodiment of the disclosure, one or more of SPs 106, 107. 111 comprises a haptic feedback device that is operable to produce a vibration responsive to a state of activation of the SP. Optionally, the haptic feedback device is operable to produce a vibration response to an action of a camera comprised in electronic device 101 that is triggered by activation of the SPs in accordance with an embodiment of the disclosure. By way of example, the haptic feedback device may be configured to produce a vibration when the camera is triggered through SP activation to capture a photograph or a video.

In accordance with an embodiment of the disclosure, at least one of the SPs 106, 107, 111 is a “semi-pressable” SP configured to have an un-pressed state, one or more semi-pressed states, and a full-pressed state. In an embodiment of the disclosure, a semi-pressable SP comprises or is operatively connected to a transducer that is operable to interpret pre-defined operations of the semi-pressable SP as representing a semi-pressed state or a full-pressed state. Optionally, semi-pressed and full-pressed states may be detected by a transducer based on duration and/or magnitude of pressure applied to the SP. By way of example, in a situation in which the semi- or full-pressed state is based on duration of pressure applied to the SP, application of pressure for a period of time shorter than a pre-defined threshold is registered by the transducer as a semi-pressed state while application of pressure for a period of time longer than the threshold is registered as a full-pressed state.

In an embodiment in which a SP is a slide-sensitive SP in accordance with an embodiment of the disclosure, the SP is optionally configured to detect a stationary touch applied to the SP as a semi-pressed state and detect a sliding touch applied to the SP as a full-pressed state.

One or more slide-sensitive SPs may be used to interact with a graphical interface shown in screen 115 of electronic device 101. By way of example, where SP 106 and SP 107 are slide-sensitive, the electronic device may be configured so that sliding movement applied to one SP controls cursor movement in an X-axis in screen 115, and sliding movement applied to the other SP control cursor movement in a Y-axis. By way of another example, a slide-sensitive SP may be used to scroll through a menu displayed on screen 115.

In an embodiment, AWD 100 comprising a camera is configured to activate an autofocus mechanism (not shown) and a light meter (not shown) responsive to the semi-pressable SP being pressed to a semi-pressed state. In an embodiment, maintaining the pressure of the semi-pressable SP at the semi-pressed state maintains the focusing point and allows for re-composition if desired, and further depressing the semi-pressable SP to the full-pressed state activates image capture in the camera. In an embodiment, AWD 100 comprising a camera is configured to capture a photograph responsive to the semi-pressable SP being pressed to a semi-pressed state, and further depressing the semi-pressable SP to a full-pressed state activates video capture. By way of example, a stationary grip applied to the SPs activates still-image capture and a downwards sliding motion applied to the SPs activates video capture.

In accordance with an embodiment of the disclosure, captured images may be stored on a removable memory card (not shown) housed within the device. Additionally, or alternatively, data may be transferred to a personal electronic or smart phone via, for example, a wireless connection such as Bluetooth or a wired connection via, by way of example, a micro-USB port (not shown) on the device.

Whereas the Figures showed a AWD 100 comprising an armband adapted for encircling an arm or portion thereof such as a forearm or a wrist, it will be appreciated that the device may be readily adapted for being worn in the leg or a portion therof such as an ankle.

There is therefore provided in accordance with an embodiment of the disclosure, an image-sensing wrist-wearable device comprising: a electronic device; an first strap and a second strap physically connected to the electronic device; one or more pressure sensitive pads (SPs); and a forward-looking sensor (FLS), operable to capture an image, comprised in the electronic device and configured to initiate image capture responsive to activation of the one or more SPs. Optionally, the FLS comprises at least one of: a camera, a radar sensor, a lidar sensor or a range finder sensor.

In an embodiment of the disclosure, the one or more SPs are positioned in the wrist-wearable device such that the camera initiates image capture responsive to pressure applied to a portion of the first and second straps respectively. Optionally, first strap comprises a first SP and the second strap comprises a second SP. Optionally, the FLS is configured to initiate image capture responsive to simultaneous activation of the first and second SPs. Optionally, at least one of the first and second SPs is a slide sensitive SP, and the FLS is configured to initiate image capture responsive to a sliding motion applied to the slide-sensitive SP. Optionally, the first and second SPs are slide sensitive SPs, and the FLS is configured to initiate image capture responsive to a sliding motion applied simultaneously to the first and second SPs. Optionally, the camera is configured to initiate image capture responsive to a sliding motion applied on the first and/or second SPs in a direction away from the electronic device.

In an embodiment of the disclosure, the slide-sensitive SP comprises a plurality of non-slide-sensitive SPs arranged linearly along a longitudinal segment of the armband and operatively connected to a transducer operable to interpret a sequence of activations of adjacent non-slide-sensitive SPs as a sliding motion. Optionally, the plurality of non-slide-sensitive SPs consists of between 2 and 6 non-slide-sensitive SPs.

In an embodiment of the disclosure, the first and second SPs are embedded, respectively, within the first strap and the second strap. Optionally, the first and second straps comprise a plurality of location indicators, the position of each location indicator corresponding to a location of the first SP or the second SP. Optionally, the location indicators comprise one or more of: an indentation, a protrusion, a marking, or a textured surface. Optionally, a location of a sub-region of the first SP or the second SP is indicated by a location indicator.

In an embodiment of the disclosure, the image-sensing wrist-wearable device comprises a third SP situated on the underside of the electronic device, and the FLS is configured to initiate image capture responsive to activation of the third SP. Optionally, the first strap comprises a first SP and the second strap comprises a second SP, and the FLS is configured to initiate image capture responsive to simultaneous activation of the first, second, and third SPs. Optionally, the third SP comprises an electrode or optical sensor operable to transduce signals relevant for an ECG or heartrate monitoring functionality.

In an embodiment of the disclosure, at least one of the one or more SPs is a semi-pressable SP that is configured to have an un-pressed state, a semi-pressed state, and a full-pressed state. Optionally, the semi-pressed state of the SP is detected responsive to pressure being applied to the SP for a period of time less than a specific threshold and the full-pressed state is detected responsive to pressure being applied to the SPs for a period of time greater than the specific threshold. Optionally, the semi-pressable SP is slide sensitive, and the semi-pressed state is detected responsive to a stationary touch applied to the SP, and the full-pressed state is detected responsive to a sliding motion applied to the SPs. Optionally, the FLS comprises a camera that is configured to activate an autofocus and a light meter responsive to the semi-pressable SP being in the semi-pressed state and configured to initiate image capture responsive to the semi-pressable SP being in the full-pressed state. Optionally, the FLS comprises a camera that is configured to initiate still-image capture responsive to the semi-pressable SP being in the semi-pressed state and configured to initiate video capture responsive to the semi-pressable SP being in the full-pressed state.

There is also provided in accordance with an embodiment of the disclosure a wearable apparatus comprising: an electronic device; an armband suitable for encircling a portion of a user's arm and physically connected to the electronic device; one or more sensor pads (SPs) operably connected to the electronic device; and a functional module comprised in the electronic device configured to perform a function responsive to activation of the one or more SPs. Optionally, the one or more SPs are positioned in the wearable device so that the functional module performs the function responsive to pressure applied to the armband.

In an embodiment of the disclosure, the apparatus comprising a first SP and a second SP. Optionally, the functional module is configured to perform the function responsive to a temporally overlapping activation of the first and second SPs. Optionally, the first and second SPs are comprised in or attached to two different regions on the arm band. Optionally, the first SP is situated on the armband to be located at or near an ulnar side of a user's forearm or wrist when worn by the user; and the second SP is situated on the armband to be located at or near a radial side of a user's forearm or wrist when worn by the user.

In an embodiment of the disclosure, the functional module is a hardware module comprised in the electronic device and/or a software module that is performed by a processor comprised in the electronic device based on a set of instructions and/or data stored in a memory comprised in the electronic device. Optionally, the functional module comprises one or a combination of two or more of: a wireless communication module; a light source; a sound recording module, a location tracking module; a graphical user interface; a voice-command module; an image capture device; a chemical sensor for detecting presence of a volatile chemical; and a bio-sensor operable to track biological data from a user wearing the wearable apparatus.

In an embodiment of the disclosure, activation of the one or more SPs instructs the electronic device to wirelessly transmit a text-based message; initiate a voice communication channel with a pre-defined target; or receive an incoming request for voice communication.

In an embodiment of the disclosure, the at least one SP comprises a slide-sensitive SP situated on the armband, and the functional module is configured to perform the function responsive to detecting a sliding motion along the slide-sensitive SP. Optionally, the sliding motion is in a direction along the armband away from the electronic device. Optionally, wherein the functional module is a graphical user interface, the function performed responsive to activation of the one or more SPs comprise moving a cursor displayed on a screen comprised in the electronic device or scrolling through a menu displayed on the screen. Optionally, the slide-sensitive SP is operable to detect sliding movement along a two-dimensional surface.

In an embodiment of the disclosure, the apparatus comprises a third SP situated on an underside surface of the electronic device that faces an arm of a user when the apparatus is worn by the user, and the functional module is configured to perform the function responsive to activation of the third SP. Optionally, the armband comprises a first SP, and the functional module is configured to perform the function responsive to a temporally overlapping activation of the first and third SPs.

In an embodiment of the disclosure, one or more SPs comprises a semi-pres sable SP that is configured to have an un-pressed state, a semi-pressed state, and a full-pressed state. Optionally, the semi-pressed state of the SP is detected responsive to pressure being applied to the SP for a period of time less than a specific duration threshold and the full-pressed state is detected responsive to pressure being applied to the SPs for a duration greater than the specific duration threshold. Optionally, the semi-pressable SP is slide sensitive, and the semi-pressed state is detected responsive to a stationary touch applied to the SP, and the full-pressed state is detected responsive to a sliding motion applied to the SPs.

In an embodiment of the disclosure, the armband comprises two straps that are respectively connected to opposite sides of the electronic device and are connectable with each other to form a loop suitable for encircling a portion of a user's arm.

In an embodiment of the disclosure, the one or more SPs are positioned in the wearable device so that when the device is being worm, the functional module performs the function responsive to at least a portion of the armband being pulled in a dorsal to ventral direction with respect to the arm.

There is also provided in accordance with an embodiment of the disclosure a smart armband comprising: an armband; and at least one sensor pad (SP) that is situated on the armband and operable to be activated by applied pressure or contact on the armband. Optionally, the armband is physically connectable with an electronic device; and the at least one SP is operatively connectable with the electronic device through a wired or wireless connection to transmit an operating instruction to the electronic device responsive to activation of the at least one SP.

In an embodiment of the disclosure, the smart armband optionally comprises a first

SP and a second SP. Optionally, the first SP is situated on the armband to be located at or near an ulnar side of a user's forearm or wrist when worn by a user. Optionally, the second SP is situated on the armband to be located at or near a radial side of a user's forearm or wrist when worn by the user.

In an embodiment of the disclosure, the smart armband comprises two straps that, respectively, comprises a first end connectable with the electronic device, and a second end connectable with the

In the description and claims of the present application, each of the verbs, “comprise”, “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments. Some embodiments utilize only some of the features or possible combinations of the features. Variations of embodiments of the disclosure that are described, and embodiments comprising different combinations of features noted in the described embodiments, will occur to persons of the art. The scope of the invention is limited only by the claims.

1. A wearable apparatus comprising:
an electronic device;
an armband suitable for encircling a portion of a user's arm and physically connected to the electronic device;
one or more sensor pads (SPs) operably connected to the electronic device; and
a functional module comprised in the electronic device configured to perform a function responsive to activation of the one or more SPs,
wherein the one or more SPs are positioned in the wearable device so that the functional module performs the function responsive to pressure applied to the armband.

2. The wearable apparatus of claim 1 comprising a first SP and a second SP, wherein the functional module is configured to perform the function responsive to a temporally overlapping activation of the first and second SPs.

3. The wearable apparatus of claim 2, wherein the first and second SPs are comprised in or attached to two different regions on the arm band.

4. The wearable apparatus of claim 3, wherein:
the first SP is situated on the armband to be located at or near an ulnar side of a user's forearm or wrist when worn by the user; and
the second SP is situated on the armband to be located at or near a radial side of a user's forearm or wrist when worn by the user.

5. The wearable apparatus of claim 1, wherein the functional module is:
a hardware module comprised in the electronic device; and/or
a software module that is performed by a processor comprised in the electronic device based on a set of instructions and/or data stored in a memory comprised in the electronic device.

6. The wearable apparatus of claim 5, wherein the functional module comprises at least one of: a wireless communication module; a light source; a sound recording module, a location tracking module; a graphical user interface; a voice-command module; an image capture device; a chemical sensor for detecting presence of a volatile chemical; and a bio-sensor operable to track biological data from a user wearing the wearable apparatus.

7. The wearable apparatus of claim 6, wherein activation of the one or more SPs instructs the electronic device to wirelessly transmit a text-based message; initiate a voice communication channel with a pre-defined target; or receive an incoming request for voice communication.

8. The wearable apparatus of claim 1, wherein the at least one SP comprises a slide-sensitive SP situated on the armband, and the functional module is configured to perform the function responsive to detecting a sliding motion along the slide-sensitive SP.

9. The wearable apparatus of claim 8 wherein the sliding motion is in a direction along the armband away from the electronic device.

10. The wearable apparatus of claim 8, wherein the functional module is a graphical user interface, and the function performed responsive to activation of the one or more SPs comprise moving a cursor displayed on a screen comprised in the electronic device or scrolling through a menu displayed on the screen.

11. The wearable apparatus of claim 10, wherein the slide-sensitive SP is operable to detect sliding movement along a two-dimensional surface.

12. The wearable apparatus of claim 1 comprising a third SP situated on an underside surface of the electronic device that faces an arm of a user when the apparatus is worn by the user, and the functional module is configured to perform the function responsive to activation of the third SP.

13. The wearable apparatus of claim 12, wherein the armband comprises a first SP, and the functional module is configured to perform the function responsive to a temporally overlapping activation of the first and third SPs.

14. The wearable apparatus of claim 1, wherein the one or more SPs comprises a semi-pressable SP that is configured to have an un-pressed state, a semi-pressed state, and a full-pressed state.

15. The wearable apparatus of claim 14, wherein:
the semi-pressed state of the SP is detected responsive to pressure being applied to the SP for a period of time less than a specific duration threshold and the full-pressed state is detected responsive to pressure being applied to the SPs for a duration greater than the specific duration threshold; or
the semi-pressable SP is slide sensitive, and the semi-pressed state is detected responsive to a stationary touch applied to the SP, and the full-pressed state is detected responsive to a sliding motion applied to the SPs.

16. The wearable apparatus of claim 1, wherein the armband comprises two straps that are respectively connected to opposite sides of the electronic device and are connectable with each other to form a loop suitable for encircling a portion of a user's arm.

17. The wearable apparatus of claim 1, wherein the one or more SPs are positioned in the wearable device so that when the device is being worm, the functional module performs the function responsive to at least a portion of the armband being pulled in a dorsal to ventral direction with respect to the arm.

18. A smart armband comprising:
an armband; and
at least one sensor pad (SP) that is situated on the armband and operable to be activated by applied pressure or contact on the armband, wherein:
the armband is physically connectable with an electronic device; and
the at least one SP is operatively connectable with the electronic device through a wired or wireless connection to transmit an operating instruction to the electronic device responsive to activation of the at least one SP.

19. The smart armband of claim 18, comprising a first SP and a second SP, wherein
the first SP is situated on the armband to be located at or near an ulnar side of a user's forearm or wrist when worn by a user; and
the second SP is situated on the armband to be located at or near a radial side of a user's forearm or wrist when worn by the user.

20. The smart armband of claim 18, wherein the armband comprises two straps that, respectively, comprises a first end connectable with the electronic device, and a second end connectable with the other strap to form a loop suitable for encircling a portion of a user's arm.
